(19) United States
(12) Patent Application Publication
(10) Pub. No.: US 2024/0395018 A1
(43) Pub. Date: Nov. 28, 2024

(54) MODELLING GEOSPATIAL DATA

(71) Applicant: BRITISH TELECOMMUNICATIONS PUBLIC LIMITED COMPANY, London (GB)

(72) Inventors: Jonathan ROSCOE, London (GB); Robert HERCOCK, London (GB)

(21) Appl. No.: 18/693,562

(22) PCT Filed: Aug. 24, 2022
(86) PCT No.: PCT/EP2022/073619

§ 371 Date: Mar. 20, 2024

(30) Foreign Application Priority Data
Sep. 21, 2021 (GB) 2113472.1

(51) Int. Cl. G06V 10/764; G06T 3/40; G06V 20/40; G06V 20/52

(52) U.S. Cl. CPC G06V 10/764; G06T 3/40; G06V 20/44; G06V 20/52

(57) ABSTRACT

A computer implemented method for detecting an occurrence of an event indicated by a set of data records, the event being associated with an event type, can include receiving a plurality of sets of training data records, each training data record having associated a geospatial indication, wherein the training data records in each set relate to an occurrence of an event of the event type; generating a training bitmap to represent each set of training data records in the plurality of sets, the bitmap defining a representation of a geospatial region including the locations identified by geospatial indications of training data records in the set, and the bitmap including identifications of each training data record in the set mapped into the geospatial region of the bitmap; training an image classifier based on each training bitmap such that the trained classifier is operable to classify an input bitmap as indicating an event of the event type.

### PRIORITY CLAIM

The present application is a National Phase entry of PCT Application No. PCT/EP2022/073619, filed Aug. 24, 2022, which claims priority from GB Application No. 2113472.1, filed Sep. 21, 2021, each of which hereby fully incorporated herein by reference.

### TECHNICAL FIELD

The present disclosure relates to the modelling of geospatial data.

### BACKGROUND

Physical occurrences such as physical security occurrences are beneficially detected and identified in good time for reactive, remediative and/or responsive measures. For example, criminal acts against equipment used by the telecommunications industry can result in considerable costs for communications providers and degradation or interruption of service for their customers.

### SUMMARY

It is therefore beneficial to detect occurrences of such events in an effective and timely manner.

According to a first aspect of the present disclosure, there is provided a computer implemented method for detecting an occurrence of an event indicated by a set of data records, the event being associated with an event type, the method comprising: receiving a plurality of sets of training data records, each training data record having associated a geospatial indication, wherein the training data records in each set relate to an occurrence of an event of the event type; generating a training bitmap to represent each set of training data records in the plurality of sets, the bitmap defining a representation of a geospatial region including the locations identified by geospatial indications of training data records in the set, and the bitmap including identifications of each training data record in the set mapped into the geospatial region of the bitmap; training an image classifier based on each training bitmap such that the trained classifier is operable to classify an input bitmap as indicating an event of the event type.

In some embodiments, the method further comprises receiving an input bitmap; and processing the input bitmap by the trained image classifier to determine if the input bitmap indicates an event of the event type.

In some embodiments, the input bitmap is generated to represent a set of input data records each having associated a geospatial indication.

In some embodiments, the geospatial indication is one of: an indication of a geospatial location; and an indication of a geospatial region.

In some embodiments, the training bitmaps have common dimensions.

In some embodiments, one or more of the training bitmaps is adjusted by one or more of: scaling; and cropping to adapt the bitmap to the common dimensions.

In some embodiments, the training and input bitmaps have the common dimensions.

In some embodiments, the input bitmap is adjusted by one or more of: scaling; and cropping to adapt the bitmap to the common dimensions.

In some embodiments, the event type is a security event and the training data records are records of occurrences occurring at a location.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of implementations of the present disclosure.

FIG. 2 is a component diagram of an arrangement for detecting an occurrence of an event indicated by a set of data records according to an exemplary implementation of the present disclosure.

FIG. 3 is a flowchart of a method for detecting an occurrence of an event indicated by a set of data records according to an exemplary implementation of the present disclosure.

### DETAILED DESCRIPTION

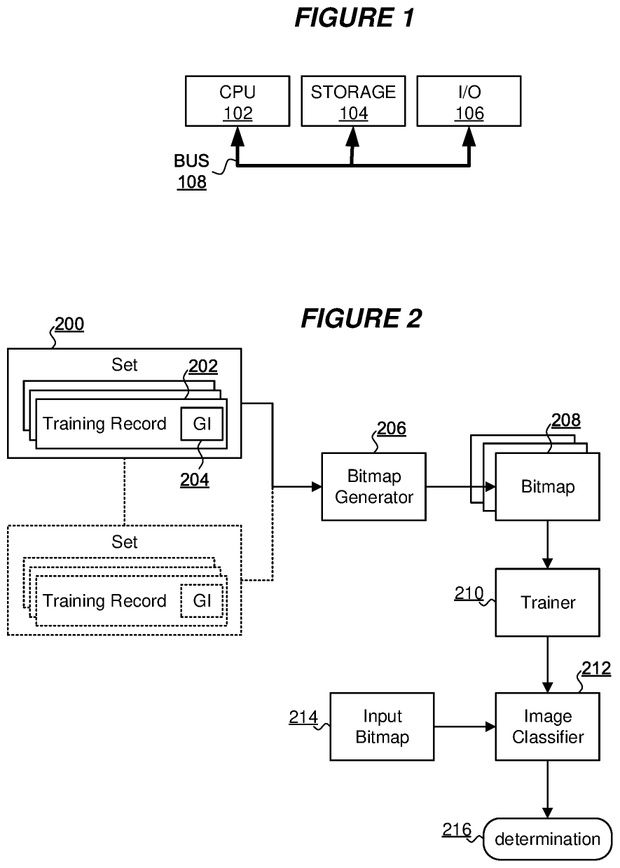

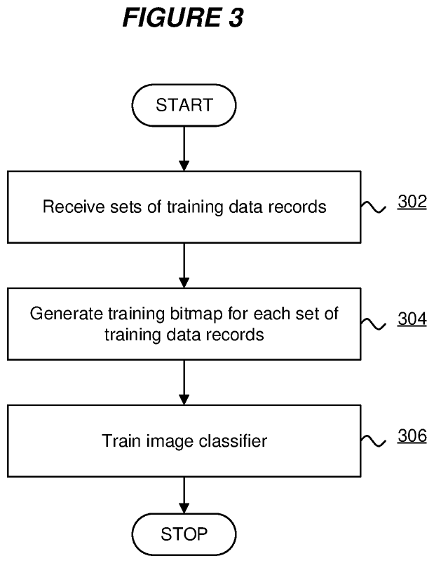

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Physical occurrences such as physical security occurrences involving happenings taking place at one or a number of geospatial locations can be indicative of an event such as a security event. For example, in the telecommunications industry, an event such as criminal damage to telecommunications equipment such as a cellular tower, cabinet, pole or the like, can occur at a geospatial location and can involve occurrences related to, and/or indicative of, the event occurring in one or more geospatial locations. Similarly, criminal activity can be associated with occurrences taking place at one or more geospatial locations, such occurrences being potentially disparate. For example, the presence of an entity or individual at a first location, the undertaking of one or more particular behaviors at a second location, the detection of a vehicle at a third location by automated number plate recognition, and the occurrence of a crime at a fourth location can all be related and indicative of criminal behavior leading to the crime.

Implementations of embodiments of the present disclosure provide for the detection of an event indicated by a set of data records each having associated a geospatial indication of a location or region. The event is associated with an event type (such as a particular crime such as equipment theft or cell-tower vandalism, or any suitable event type at any suitable level of granularity as will be apparent to those skilled in the art). In particular, sets of training data records having associated geospatial indicators that are each indicative of an event of the event type are used to train a classifier for subsequent processing of an input set of data records with geospatial indicators so as to determine whether the input set of data records is indicative of an event of the event type.

Challenges arise in the formulation of training data and input data for such a classifier since each data record in a set of data records is indicative of a happening at a geospatial location, and the particular geospatial locations for data records relating to an event may not be expected to be reproduced exactly in subsequent comparable occurrences of events of the same event type. Rather, relative similarity between events and their geospatial location can be used, though such relative similarity may itself differ between occurrences of events for reasons such as differences in distance or orientation of occurrences. Accordingly, implementations of the present disclosure employ a conversion process by which a set of data records attributed to an occurrence are converted to a composite representation as a bitmap. The bitmap is generated to define a representation of a geospatial region including geospatial locations identified by the geospatial indications in data records of a set of records. A bitmap generated for each set of training data records is thus used to train any suitable image classifier. Subsequently, the trained classifier is operable to classify an input bitmap generated to represent a set of input data records to determine if the input records are indicative of an occurrence of an event of the event type. Thus, through the generation of a composite bitmap representation of each set of data records, the image classifier is operable to classify input bitmaps according to event type.

To overcome differences of geospatial scale between different sets of data records, bitmaps can be generated according to common dimensions such that each bitmap indicates relative geospatial relationships between data records in a set irrespective of differences in scale between geospatial locations in records of different sets. Thus, bitmaps can be adjusted by scaling and/or cropping a geospatial region represented therein to conform to the common dimensions across bitmaps.

Further, additional information can be stored within a bitmap such as indications of a type, severity, frequency or other attribute of an occurrence indicated in each of one or more data records within a set. Further, additional information such as temporal information whether absolute or relative, altitude, intensity and other beneficial characteristics can be indicated for data records in the bitmap. One way to indicate such information in a bitmap is by the use of pixel intensity, color or other pixel characteristics in the bitmap, for example.

FIG. 2 is a component diagram of an arrangement for detecting an occurrence of an event indicated by a set of data records according to an exemplary implementation of the present disclosure. An image classifier 212 is provided as any suitable classifier for classifying bitmap images as will be apparent to those skilled in the art. For example, comparison of an image to a repository or database of images can be employed, where such database of images is constituted as a training data set of images. Such comparison can be achieved by extracting vector coordinates and using active contours, for example, to find a best fit. Alternatively, a machine learning classifier such as a neural network or the like may be employed, trained using a training data set of images.

The classifier 212 is thus trained by a trainer 210 as a hardware, software, firmware or combination component arranged to provide requisite training of the image classifier based on training examples constituted as a set of bitmaps 208. Each bitmap in the set of bitmaps is generated by a bitmap generator from a training set 200 of training data records 202, each record having associated a geospatial indicator 204. Each set 200 of training records 202 relate to an occurrence of an event of an event type such that a plurality of such sets 200 constitutes a training data set of positive training examples actively identified as related to an occurrence of an event of the event type. In some implementations, such as where a machine learning classifier 212 is employed, a further set of negative training examples can be employed in which sets of training records with geospatial indications that are known not to be associated with an occurrence of an event of the event type can be provided. Such negative training examples can optionally be provided to enhance such classifiers, such as through training by a process of backpropagation as is known to those skilled in the art.

The bitmap generator 206 is a hardware, software, firmware or combination component arranged to generate a training bitmap to represent each set 200 of training data records 202 in a plurality of sets. In particular, the bitmap generator 206 generates each bitmap to define a representation of a geospatial region including the locations identified by geospatial indications in each training data record in a set 200. The bitmap generator 206 includes an identification of each training data record in the set 200 mapped into the geospatial region of the bitmap 208. As previously described, additional information pertaining to a training record 202 can be optionally indicated within the bitmap 208 such as by the use of pixel intensity, color or other pixel characteristics in the bitmap.

Thus, the bitmap generator 206 generates bitmaps 208 for each of the training sets 200 of training records 202, each set of positive training examples relating to an occurrence of an event of the event type, for use by the trainer 210 to train the image classifier 212 to classify image bitmaps as indicative of an event of the event type. In this way, the image classifier 212 is operable to classify an input bitmap 214 as indicating an event of the event type. In use, an input bitmap 214 is received and processed by the image classifier to arrive at a determination 216 of whether the image bitmap indicates an event of the event type. Such input bitmaps 214 can be generated to represent a set of input data records each having associated a geospatial indication, such as by a bitmap generator 206 of the type described above.

FIG. 2 is a flowchart of a method for detecting an occurrence of an event indicated by a set of data records according to an exemplary implementation of the present disclosure. Initially at 302, the method receives sets 200 of training data records 202 including positive training examples indicating an event of an event type. At 304 the method generates a training bitmap 208 for each set 200 of training data records 202. At 306 a trainer 210 trains the image classifier 212 to classify an input bitmap as indicating an event of the event type.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for detecting an occurrence of an event indicated by a set of data records, the event being associated with an event type, the method comprising:
receiving a plurality of sets of training data records, each training data record in the plurality of sets having associated a geospatial indication and relating to an occurrence of an event of the event type;
generating a training bitmap to represent each set of training data records in the plurality of sets, the training bitmap defining a representation of a geospatial region including locations identified by geospatial indications of training data records in the set, and the training bitmap including identifications of each training data record in the set mapped into the geospatial region of the training bitmap; and
training an image classifier based on each training bitmap such that the trained image classifier is operable to classify an input bitmap as indicating an event of the event type.

2. The method of claim 1, further comprising:
receiving an input bitmap; and
processing the input bitmap by the trained image classifier to determine if the input bitmap indicates an event of the event type.

3. The method of claim 2, wherein the input bitmap is generated to represent a set of input data records each having associated a geospatial indication.

4. The method of claim 1, wherein the geospatial indication is one of: an indication of a geospatial location; and an indication of a geospatial region.

5. The method of claim 1, wherein the training bitmaps have common dimensions.

6. The method of claim 5, wherein one or more of the training bitmaps is adjusted by one or more of: scaling; or cropping to adapt the training bitmap to the common dimensions.

7. The method of claim 5, wherein the training bitmaps and the input bitmaps have the common dimensions.

8. The method of claim 7, wherein the input bitmap is adjusted by one or more of: scaling; or cropping to adapt the input bitmap to the common dimensions.

9. The method of claim 1, wherein the event type is a security event and the training data records are records of occurrences occurring at a location.

10. A computer system comprising a processor and memory storing computer program code for performing the method of claim 1.

11. A non-transitory computer-readable storage medium comprising computer program code to, when loaded into a computer system and executed thereon, cause the computer system to perform the method as claimed in claim 1.
